(19) United States
(12) Patent Application Publication
(10) Pub. No.: US 2014/0122153 A1
(43) Pub. Date: May 1, 2014

(54) FAVORITE AND SERENDIPITOUS EVENT CORRELATION AND NOTIFICATION

(71) Applicant: DoWhatILikeBest, LLC, Draper, UT (US)

(72) Inventor: Alan Truitt, Draper, UT (US)

(73) Assignee: DoWhatILikeBest, LLC, Draper, UT (US)

(21) Appl. No.: 14/069,247

(22) Filed: Oct. 31, 2013

Related U.S. Application Data
(60) Provisional application No. 61/720,594, filed on Oct. 31, 2012.

(51) Int. Cl. G06Q 10/10

(52) U.S. Cl. CPC G06Q 10/1095
USPC 705/7.19

(57) ABSTRACT

An apparatus identifying events is disclosed. A method also performs the functions of the apparatus. The apparatus includes a user profile module that receives profile information of a user. The profile information includes activities preferred by the user, events preferred by the user and interests of the user. The apparatus includes an event search module that identifies events that correspond to an event planned by the user, events preferred by the user and/or interests of the user. Each event includes a location of the event and timing information of the event. The apparatus includes a correlation module that selects two or more events identified by the event search module that occur within a travel window of time and within a specified distance. The apparatus includes a notification module that notifies the user of the events selected by the correlation module.

### CROSS-REFERENCE TO RELATED APPLICATIONS

This application claims priority to U.S. Provisional Patent Application No. 61/720,594 entitled “FAVORITE EVENT CORRELATION AND NOTIFICATION” and filed on Oct. 31, 2012 for Alan Truitt, which is incorporated herein by reference.

### FIELD

The subject matter disclosed herein relates to event planning and more particularly relates to providing information about two or more events that are of interest to a user and are located within a travel window of time and within a specified distance.

### BACKGROUND

Often events happen in a particular location and people that attend the event are often fans, patrons, or otherwise have an interest in the event. Traveler often travel to particular cities for business or pleasure and events may occur in or around the city that are of interest to the traveler and in some cases the events happen within a particular travel window of time associated with the travel. In some cases, events that are of interest to a person or traveler happen within a few days of each other and happen close together. Such occurrences may be rare. A person or traveler may miss the events happening together and another opportunity to attend similar events happening within a few days of each other and close together may not occur for a long time.

### BRIEF SUMMARY

An apparatus identifying events is disclosed. A method also performs the functions of the apparatus. The apparatus includes a user profile module that receives profile information of a user. The profile information includes activities preferred by the user, events preferred by the user and interests of the user. In one embodiment, the apparatus includes an event search module that identifies events that correspond to an event planned by the user, events preferred by the user and/or interests of the user. Each event includes a location of the event and timing information of the event. The apparatus, in one embodiment, includes a correlation module that selects two or more events identified by the event search module that occur within a travel window of time and within a specified distance. The apparatus, in one embodiment, includes a notification module that notifies the user of the events selected by the correlation module.

In one embodiment, the apparatus includes an activity module that identifies activities matching interests of the user within the specified distance of the selected events. The identified activities include activities in which the user may participate within the travel window. The notification module also notifies the user of the identified activities. In another embodiment, the apparatus includes a calendar module that interfaces with a calendar program of a user to determine a travel time and a travel location of the user. The correlation module also selects events identified by the event search module that occur at the travel location during the travel time and/or within a specified time just before or after the travel time of the user and the activity module identifies activities matching interests of the user at the travel location of the user and during the travel time and/or a specified time just before or after the travel time of the user. In another embodiment, the activity module also interfaces with one or more websites that provide information regarding activities matching interests of the user such that the activity module identifies activities that are available to the user at the time of the travel window and/or are predicted to be above a quality threshold during the travel window.

In one embodiment, the travel window includes an amount of time a user allocates for a vacation. In another embodiment, the profile information received by the user profile module includes profile information for two or more users with one or more events preferred by the two or more users and interests of the two or more users. In another embodiment, the specified distance includes a maximum distance the user determines that the user is willing travel after arriving to attend the identified events. The maximum distance may be a radius from a location, a distance between events, and/or a distance from a point near the location of the identified events. In another embodiment, the apparatus includes a probability module that calculates a probability of the events selected by the correlation module occurring at a future time at a location and within a travel window of time and communicates the probability to the user.

In one embodiment, the user profile module receives profile information from the user through a website and/or an electronic device. In another embodiment, the event search module searches the internet using a web crawler. In another embodiment, the user profile module determines preferred location information where preferred location information includes geographic locations that the user prefers to travel. In another embodiment, the user profile module determines preferred location information by input from the user and/or determining frequent travel destinations of the user. In another embodiment, the user profile module further receives profile information of the user that includes budget constraint information and the correlation module selects events that comply with budget constraints received by the user profile module. In another embodiment, the apparatus includes a ticket module that interfaces with ticket services, reservation services, and/or reservation websites of the events selected by the correlation module to bring ticket purchase information to the user for the selected events. In another embodiment, the apparatus includes an itinerary module that creates an itinerary for the user. The itinerary includes events selected by the correlation module and within the travel window.

A method for identifying events includes receiving profile information of a user. The profile information includes activities preferred by the user, events preferred by the user and/or interests of the user. The method, in one embodiment, includes identifying events that correspond to an event planned by the user, events preferred by the user and/or interests of the user. Each event includes a location of the event and timing information of the event. The method, in one embodiment, includes selecting two or more identified events that occur within a travel window of time and within a specified distance and notifying the user of the selected events. In one embodiment, the method also includes identifying activities matching interests of the user within the specified distance of the selected events, the identified activities comprising activities in which the user may participate within the travel window, and the method also includes notifying the user of the identified activities. In another embodiment, the method includes interfacing with a calendar program of the user to determine a travel time and a travel location of the user.

Another method for selecting events includes receiving profile information of a user. The profile information includes activities preferred by the user, events preferred by the user, interests of the user, and/or potential destinations of the user. The method, in one embodiment, includes identifying a travel location and a travel time of the user and identifying events that correspond to an event planned by the user, events preferred by the user and/or interests of the user. Each event includes a location of the event and timing information of the event. In one embodiment, the method includes selecting one or more identified events that occur within the travel window and within a specified distance of the travel location, and notifying the user of the selected events. In one embodiment, identifying a travel location includes receiving input from the user identifying the travel location and the travel time of the user and/or interfacing with a calendar program of the user to determine the travel time and the travel location of the user.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for event identification in accordance with the present invention;

FIG. 2 is a schematic block diagram illustrating one embodiment of an apparatus for event identification in accordance with the present invention;

FIG. 3 is a schematic block diagram illustrating another embodiment of an apparatus for event identification in accordance with the present invention;

FIG. 4 is a schematic flow chart diagram illustrating one embodiment of a method for event identification in accordance with the present invention;

FIG. 5 is a schematic flow chart diagram illustrating another embodiment of a method for event identification in accordance with the present invention; and

FIG. 6 is a schematic flow chart diagram illustrating a third embodiment of a method for event identification in accordance with the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Aspects of the present invention are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

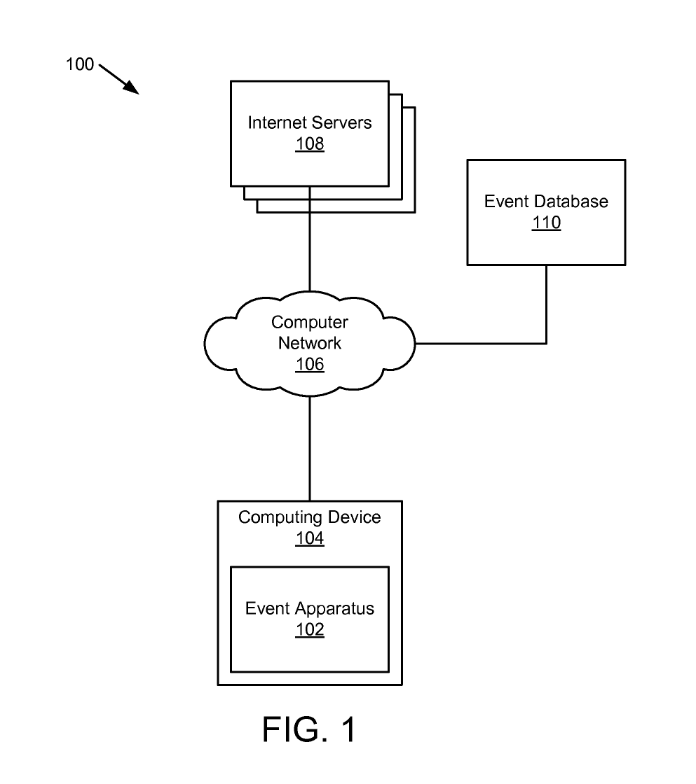

FIG. 1 is a schematic block diagram illustrating one embodiment of a system 100 for event identification in accordance with the present invention. The system 100 includes an event apparatus 102 within a computing device 104, a computer network 106, internet servers 108, and an event database 110, which are described below.

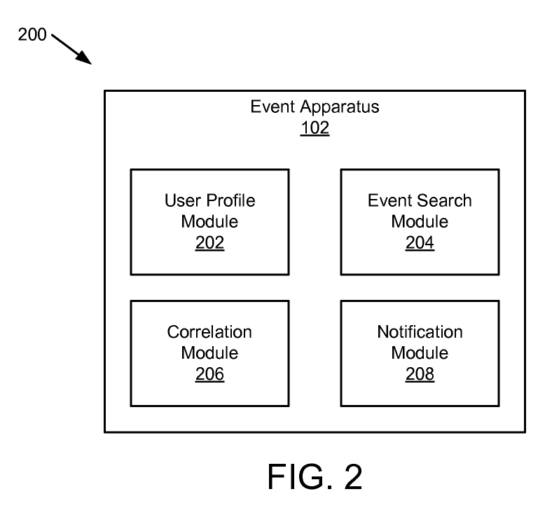

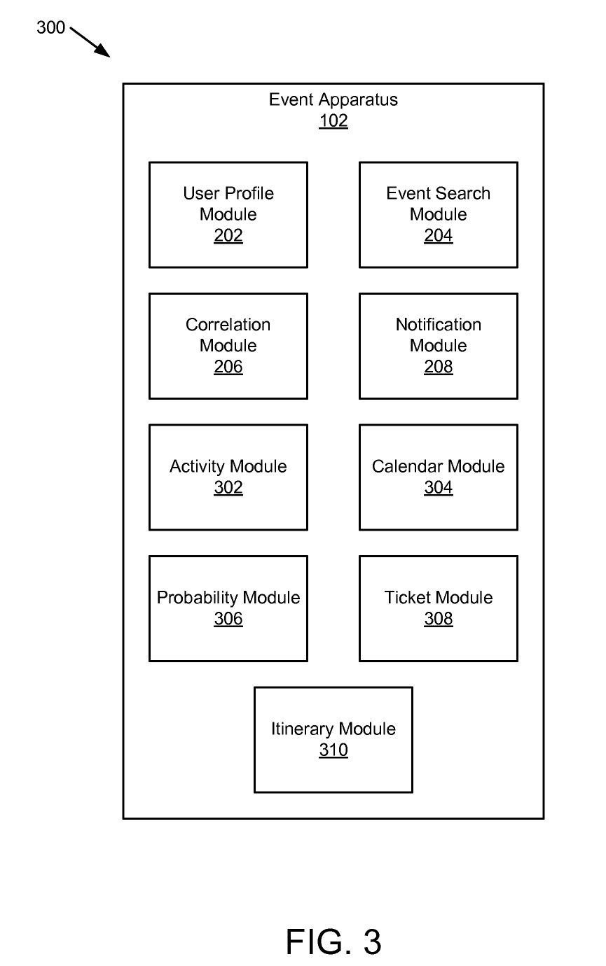

In one embodiment, the system 100 includes an event apparatus 102 within a computing device 104. Embodiments of the event apparatus 102 is describe in more detail with respect to the apparatus 200 of FIG. 2 and the apparatus 300 of FIG. 3. The computing device 104 may be a mobile phone, such as one with internet access, a tablet computer, a laptop computer, a desktop computer, a server, a workstation, or other computing device 104 accessible to a user. In one embodiment, the computing device 104 of the user is a client and the event apparatus 102 resides on a server in communication with the computing device 104. In such an embodiment, some or all of the event apparatus 102 may reside on the server and a portion of the event apparatus 102 may also be on the computing device 104. One of skill in the art will recognize other configurations where the event apparatus 102 is together on a computing device 104 or distributed such that the computing device 104 of the user may access the event apparatus 102.

The computing device 104 is connected to internet servers 108 through a computer network 106. The computer network 106 may include one or more computer networks. The computer network 106 may include a wireless network, a local area network (“LAN”), a mobile phone network, a BlueTooth™ network, an optical fiber network, a storage area network (“SAN”) and the like, as well as the internet. The computer network 106 may include switches, routers, servers, cabling, and other equipment common to a computer network.

The system 100 also includes one or more internet servers 108. The internet servers 108 are servers that are accessible over the internet and contain information that can be searched and retrieved. The internet servers 108 may host websites. For example, some internet servers 108 include information about upcoming events and event information may be included on a website. The event information may be included on one or more websites that list events and sell tickets to the events. In other embodiments, the event information may be on a website of an organization promoting an event. In another example, the internet servers 108 may include information about activities at a location. For instance, a website may include information about surfing at a particular beach and may include tide and surf conditions information. In another instance, an internet server 108 may include information about a particular big game hunt and may include information about hunting regulations and hunting license. In another example, the internet servers 108 may include weather information, seasonal information, etc. that may aid a user in selecting an event or activity. One of skill in the art will recognize other information available on an internet server 108.

In one embodiment, the system 100 includes one or more event databases 110. For example, an event database 110 may be hosted by an event planning service, a company that sells tickets, an event venue, etc. In another embodiment, the event database 110 is accessible over a private network or connection that is different than public information available on the internet servers 108. One of skill in the art will recognize other event databases 110.

FIG. 2 is a schematic block diagram illustrating one embodiment of an apparatus 200 for event identification in accordance with the present invention. The apparatus 200 includes, in one embodiment, an event apparatus 102 with a user profile module 202, an event search module 204, a correlation module 206, and a notification module 208, which are described below.

The apparatus 200, in one embodiment, includes a user profile module 202 that receives profile information of a user. The profile information includes activities preferred by the user, events preferred by the user and/or interests of the user. For example, the user profile module 202 includes a user interface available on the computing device 104 for the user to input profile information. In another embodiment, the user profile module 202 accesses user information available on the computing device 104 or available on the internet. For example, the user profile module 202 may mine user profile data from websites frequented by the user. In another embodiment, the user profile module 202 mines user profile data from browser history and other sources available on the computing device 104 or other computing devices available to the user. In another embodiment, the user profile module 202 uses profile information from a program available to the user, such as a calendar or email program used by the user.

In one embodiment, the user inputs user profile information to the user profile module 202 through a website. For example, the user may access a website designed to accept user profile information. In another embodiment, the user inputs user profile information to the user profile module 202 through an electronic device. For example, a user may enter user profile information into the computing device 104 located at an event, at an office, or other location where a user may frequent. In one embodiment, the user profile module 202 prompts the user for profile information. For example, the user profile module 202 may prompt the user for profile information in association with the user frequenting a website associated with the apparatus 200, after the user registers, or the like. One of skill in the art will recognize other ways that the user profile module 202 may receive profile information of a user.

In one embodiment, the user profile module 202 determines preferred location information of the user. The preferred location information includes, in one embodiment, geographic locations that the user prefers to travel. In another embodiment, the user profile module 202 determines preferred location information by input from the user. In another embodiment, the user profile module 202 determines preferred location information by determining frequent travel destinations of the user. For example, the user profile module 202 may mine emails, calendar information, etc. to determine where the user travels.

In one embodiment, the profile information received by the user profile module 202 is for more than one person. For example, the user profile module 202 may receive profile information for more than one person and may create a composite profile. The composite profile, in one embodiment, identifies interests, events, favorite teams, etc. that are common between the users. In another embodiment, the composite profile identifies interests, events, favorite teams, etc. at least one individual that may not be of interest to one or more other individuals that are included in the composite profile. In another embodiment, users may indicate interests and may include dislikes and the composite profile may exclude interests, teams, etc. that are indicated as a dislike to one or more individuals in the composite profile while other interests, teams, events, etc. may be included in the composite profile that are not included as interests in profiles of some of the individuals but are not included as dislikes of the individuals.

The user profile module 202 may create a composite profile for spouses, a family, a team, common travelers, or other grouping of individuals. One of skill in the art will recognize other ways that the user profile module 202 may group profiles of individuals and other ways to identify interests, favorite teams, favorite events, etc.

In one embodiment, the apparatus 200 includes an event search module 204 that identifies events that correspond to events preferred by the user and/or interests of the user. Each event includes a location of the event and timing information of the event. For example, the event search module 204 may search the internet for events and may include a web crawler that systematically searches the internet for events and event information. In another embodiment, the event search module 204 periodically searches known websites that include event information. In another embodiment, the event search module 204 receives event information from an event search provider.

In one embodiment, the event search module 204 identifies an event planned by the user. For example, the event search module 204 may identify an event in a calendar of the user, may identify an event from an email of the user, or other resource accessed by the user. The event search module 204 may identify that the user will travel to a location based on a planned event of the user, based on airline information, etc. The event search module 204 may identify a time associated with the event. For example, the event search module 204 may determine that a meeting will be held in a certain location on a certain day and/or time. In another example, the event search module 204 may identify one or more flights and may identify a flight destination as a location and a time between flights as a travel window of time.

In another embodiment, the event search module 204 may identify a combination of events from user information. For example, the event search module 204 may identify airline flights, bus travel, etc. to determine a destination and travel window and may identify a meeting or other event that may expand a location and limit times for other searched events.

In one embodiment, the event search module 204 identifies events based on input from a user. For example, the user may input a location and a window of travel, a particular date, a radius, etc. and the event search module 204 may commence identifying events within parameters set by the user, such as the location, travel window, etc. For instance, a user may input a destination where a meeting will be held and the event search module 204 may then identify events at the destination or nearby and within a certain number of days of the meeting. In another instance, the user may input a destination and a window of time when the user will be at the destination and the event search module 204 may identify events within or just outside of the travel window at or near the destination.

In one embodiment, the user profile module 202 receives information from the user regarding user preferences such as number of events selected by the correlation module 206, maximum travel distance, maximum travel window, preferred travel locations, and similar limits. For example, in addition to preferences regarding preferred events, sports teams, performers, etc., the user profile module 202 may allow a user to select two events occurring together, three events occurring together, etc. as a lower threshold for the correlation module to select events and/or activities.

An event may include a concert of a musical group, a ballet, an opera, a play, a sporting event, a competition, a race such as a running race, a bicycle race, a motor sport race, etc., political event, a charity event, a movie premier, a convention, a show, and the like. The event search module 204 may also limit identified events based on profile information. For example, a user may be interested in a particular matchup of two sports teams or may have one or more favorite sports teams. The user may express an interest in opera and the event search module 204 may identify operas along with locations and times. In another example, the profile may include information about particular sports in which the user participates and the event search module 204 may identify competitions, charity events, etc. where the user may participate in a sport. In another embodiment, the user may express an interest in a particular hobby, such as vintage cars, and the event search module 204 may identify events associated with vintage cars such as car shows. One of skill in the art will recognize other events that may be identified by the event search module 204.

In one embodiment, the apparatus 200 includes a correlation module 206 that selects two or more events identified by the event search module 204 that occur within a travel window of time and within a specified distance. The specified distance includes a distance between the identified events. In one embodiment, the travel window includes a typical amount of time that a user may be away from home traveling, on vacation, on a business trip, etc. For example, a travel window may include a few days of travel, such as a weekend or a week. In some instances, the travel window may be lengthier, such as two weeks or a month. In another embodiment, the user sets a travel window using the user profile module 202. In another embodiment, the correlation module 206 includes a default maximum travel window, such four days. In another embodiment, the default travel window may be overridden by a user preference received by the user profile module 202. Typically a travel window is a time period that a user considers an acceptable travel time, based on factors such as travel habits, culture, business trip patterns, and the like.

In one embodiment, the specified distance is a reasonable maximum distance that a user would be willing to travel to events and activities once the user arrives at a particular location. For example, the specified distance may include a radius. For instance, the radius may be a radius around a hotel in which the user is staying, a particular distance from an airport at which the user arrives, a city, a city plus certain suburbs, a particular distance measured along roads traveled between events, and the like. The specified distance may include a distance from a point near the location of the identified events. For example, if events are within a city, specified distance may be a distance from point in the center of the city. The specified distance may take into account scheduled meetings and meeting locations. The specified distance may include non-travel considerations, such as meal time, leisure time, sleep time, traffic, and the like.

In one embodiment, the specified distance may include a total expected distance traveled once the user arrives at a location. For example, the total expected distance may include travel from an airport to a hotel, from the hotel to an event, from the event to another event, from an event to the hotel, from the hotel to the airport, etc. In another embodiment, the user profile module 202 receives user profile information setting a specified travel distance. In another embodiment, the specified distance includes a default distance. In a related embodiment, user input may override the default distance. In another embodiment, the correlation module 206 may use multiple distances, such as a radius, a total distance traveled, etc. to select events. One of skill in the art will recognize other ways to determine a specified distance to limit events selected by the correlation module 206.

In one embodiment, the user profile module 202 determines particular locations that a user frequents. For example, the user may travel to certain cities and the user profile module 202 may identify the cities that the user travels to. In another embodiment, the user profile module 202 determines cities frequented by a user by interfacing with a calendar, by mining travel information from emails, files, etc. of the user, and the like. In another embodiment, the user profile module 202 receives preferred event locations from the user. The correlation module 206 may use the information about locations frequented by the user in selecting events. For example, the correlation module 206 may limit events to cities frequented by the user. In another example, the correlation module 206 may give preference to cities frequented by the user.

In one embodiment, the user profile module 202 receives profile information of the user that includes budget constraint information. The correlation module 206, in one example, selects events that comply with budget constraints received by the user profile module 202. For example, the user profile module 202 may receive a budget constraint that the use wants to limit spending for a ticket for an event to $150. The correlation module 206 may select events that cost less than $150.

In one embodiment, the correlation module 206 uses input from a user to determine a location, a travel window, a radius, etc. For example, where an event identified by the event search module 204 is a user planned event, the correlation module 206 may select one or more additional events identified by the event search module 204 that are within a travel window related to the planned event, are within a specified distance of the planned event, etc. In another example, a user may input a location and the correlation module 206 may select one or more events identified by the event search module 204 that are at or near the selected location and within a travel window selected by the user.

For instance, the user may arrive at a location for a meeting and may inquire as to what events are available within a certain time after arrival. The user may like boxing, football games of a particular team or teams, rock concerts by certain artists, basketball games of a particular team, fishing of a particular type, etc. Rather than searching individually for each artist, team, sport, etc., the user may make a single inquiry and the event search module 204 may search for events based on a user profile of the user received by the user profile module 202 and the correlation module 206 may select one or more events that within a specified travel window and at the location of the meeting. The event search module 204 may identify numerous events and activities from numerous favorite teams, sports, events, activities, etc. and the correlation module 206 may then select one or more events from the events identified by the event search module 204, all from a single trigger event, such as a calendar entry, a user request, etc.

In one embodiment, the apparatus 200 includes a notification module 208 that notifies the user of events selected by the correlation module 206. In one embodiment, the notification module 208 notifies the user by sending a message to the user. For example, the message may be an email, a popup window, a short message service (“SMS”) message (i.e. a text message), or the like. In another embodiment, the notification module 208 plays a sound to alert the user of the selected events. In one embodiment, the notification module 208 notifies the user over the computer network 106. In another embodiment, the notification module 208 notifies the user via communication channels internal to the computing device 104. One of skill in the art will recognize other ways that the notification module 208 may notify a user of selected events.

The apparatus 200 is advantageous because the apparatus 200 identifies situations where multiple events are occurring at a particular location. While other services only identify single events, the apparatus 200 selects events occurring within a particular travel window and at a particular location so that a user may be more likely to travel to the location for the events.

FIG. 3 is a schematic block diagram illustrating another embodiment of an apparatus 300 for event identification in accordance with the present invention. The apparatus 300 includes an embodiment of the event apparatus 102 with a user profile module 202, an event search module 204, a correlation module 206, and a notification module 208, which are substantially similar to those described above in relation to the apparatus 200 of FIG. 2. The apparatus 300, in various embodiments, includes one or more of an activity module 302, a calendar module 304, a probability module 306, a ticket module 308, and an itinerary module 310, which are described below.

In one embodiment, the apparatus 300 includes an activity module 302 that identifies activities matching interests of the user within the specified distance of the selected events. The identified activities include activities in which the user may participate within the travel window. The notification module 208 also notifies the user of the identified activities. Activities may include sporting events, such as skiing, surfing, hunting, fishing, tennis, horseback riding, golf, sailing, biking, and the like. Activities may also include going to a museum, going to a zoo, visiting a location such as a national park, a state capitol building, a state park, etc. Activities may overlap with events and may be identified by the event search module 204 and/or the activity module 302. For example, if the user profile module 202 includes information that the user enjoys running, the activity module 302 may identify running locations within the specified distance and the event search module 204 may identify running races within the specified distance. In another example, if the user profile module 202 includes information that the user enjoys fly fishing, the event search module 204 and/or the activity module 302 may identify locations of rivers, lakes, or streams nearby or other fly fishing resources.

In one embodiment, the activity module 302 may interfaces with one or more websites that provide information regarding activities matching interests of the user. For example, the activity module 302 may identify activities that are available to the user at the time of the travel window and/or are predicted to be above a quality threshold during the travel window. For example, if a user enjoys fly fishing, the activity module 302 may identify locations within the specified location where the user can fly fish. In another example, the activity module 302 may access information on predicted fishing conditions and the notification module 208 may notify the user of the fly fishing location and the predicted fishing conditions.

In another example, the activity module 302 may identify fly fishing at a location only if the fly fishing at the location is predicted to be above a certain level. For instance, if the predicted fly fishing at a location is predicted to be poor during the travel window, the activity module 302 may not identify the fly fishing location but if the predicted fly fishing at the location is predicted to be fair or better, the activity module 302 may identify the fly fishing location and the notification module 208 may notify the user. In one embodiment, the quality threshold may be a subjective quality, such as quality of fishing conditions. In another embodiment, the quality threshold may be a notification of whether or not an activity is available. For example, if the activity is hunting, the quality threshold may include whether or not hunting season is open during the travel window. One of skill in the art will recognize other ways that the activity module 302 may search and identify activities.

In one embodiment, the apparatus 300 includes a calendar module 304 that interfaces with a calendar program of a user to determine a travel time and a travel location of the user. For example, the calendar module 304 may search a calendar program running on a computing device 104 of the user and may identify times when the user will be traveling and where the user will be traveling. The calendar module 304 may then cooperate with the event search module 204 and correlation module 206. The correlation module 206 may select events identified by the event search module 204 that occur at the travel location during the travel time or within a specified time just before or after the travel time of the user. For example, if a user is traveling to Atlanta on a Wednesday and scheduled to return on a Friday, the correlation module 206 may select events in and around Atlanta between Wednesday and Friday or may also select events on Tuesday or Saturday where the user may extend travel plans.

In one embodiment, the activity module 302 identifies activities matching interests of the user at the travel location of the user and during the travel time or a specified time just before or after the travel time of the user. Activities identified outside of the travel window by the activity module 302 may provide the user with an opportunity to extend a business trip to participate in the identified activity.

In one embodiment, the apparatus 300 includes a probability module 306 that calculates a probability of the events selected by the correlation module occurring at a future time at a location and within a travel window and communicates the probability to the user. For example, where two or more events are happening at a particular location within a travel window, this occurrence may be serendipitous and the probability module 306 may calculate a probability that of the events happening again in the future at that location and within a similar travel window. Due to the serendipitous nature of the events occurring together, the probability of the events occurring together again in the near future may be low, thus encouraging a user to attend the selected events. In another embodiment, the probability module 306 may calculate the probability of the events happening together within a travel window, but at a different location. By calculating a probability that the events will happen again at a future time and at a future location and then communicating the probability to the user, the probability module 306 may help persuade the user to travel to the location during the travel window and attend events selected by the correlation module 206.

In another embodiment, the probability module 306 may also include activities. For example, where an activity is not continuously available, the probability module may also take into account particular times the activity is available, such as a window of time that a hunting season is open. In another embodiment, the probability module 306 includes activities with a subjective quality level, such as projected surfing conditions. For example, if events are located in Oahu, Hi. during winter and projected surfing conditions are predicted to be good because of a winter storm, the probability module 306 may calculate a probability based on similar surfing conditions happening again with the events also occurring at this location.

In one embodiment, the apparatus 300 includes a ticket module 308 that interfaces with ticket services, reservation services, and/or other reservation websites of the events selected by the correlation module 206 to bring ticket purchase information to the user for the selected events. For example, the ticket module 308 may include a link for each event such that the user may click the link for an event and purchase tickets to the event. In one embodiment, the ticket module 308 accesses ticket broker websites. In another embodiment, the ticket module 308 accesses a website of a venue for an event to access ticket purchase information.

In one embodiment, the apparatus 300 includes an itinerary module 310 that creates an itinerary comprising that creates an itinerary for the user. The itinerary may include events selected by the correlation module 206 and within the travel window. The itinerary module 310 may also include in the itinerary other activities, such as a meal at a local favorite restaurant, travel time, and the like. The itinerary module 310, in one embodiment, adjusts the itinerary based on changes in travel plans, user input, user profile information, etc. The itinerary module 310, in one embodiment, works in conjunction with the notification module 208 to notify the user of the itinerary. In another embodiment, the itinerary module 310 allows a user to influence the itinerary. For example, the user may accept or reject events and the itinerary module 310 may adjust the itinerary based on accepted events.

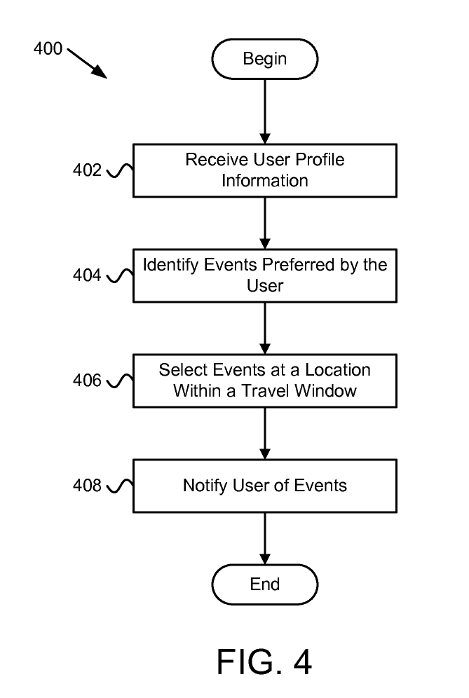

FIG. 4 is a schematic flow chart diagram illustrating one embodiment of a method 400 for event identification in accordance with the present invention. The method 400 begins and receives 402 profile information of a user. The profile information includes activities and events preferred by the user and/or interests of the user. In one embodiment, the user profile module 202 receives 402 profile information. The method 400 identifies 404 events that correspond to an event planned by the user, events preferred by the user, and interests of the user. Each event and activity includes a location of the event and timing information of the event. The method 400 may identify 404 events by searching the internet or other event database. The event search module 204, in one embodiment, identifies 404 events.

The method 400 selects 406 two or more identified events that occur within a travel window and within a specified distance. The specified distance, in one embodiment, includes a distance between the identified events. In one embodiment, the correlation module 206 selects 406 the two or more events. The method 400 notifies 408 the user of the selected events and the method 400 ends. In one embodiment, the notification module 208 notifies the user.

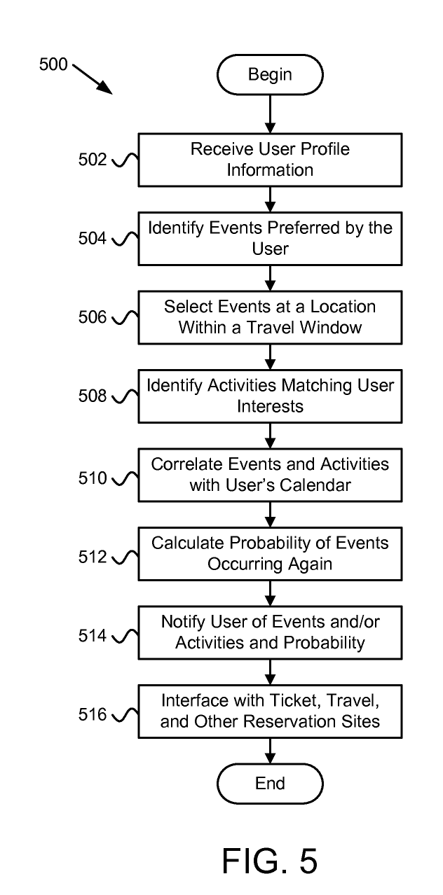

FIG. 5 is a schematic flow chart diagram illustrating another embodiment of a method 500 for event identification in accordance with the present invention. The method 500 begins and receives 502 profile information of a user. The profile information includes activities and events preferred by the user and/or interests of the user. For example, the user may input profile information at a website associated with the method 500. In another embodiment, the user input profile information may be input through an electronic device, such as a computer. In one embodiment, the user profile module 202 receives 502 profile information of the user. The method 500 identifies 504 events that correspond to events preferred by the user and interests of the user. The method 500 may search the internet to identify 504 events. Each event includes a location of the event and timing information of the event. The event search module 204, in one embodiment, identifies 504 events. The method 500 selects 506 two or more identified events that occur within a travel window and within a specified distance. The method 500 also identifies 508 activities matching interests of the user within the specified distance of the identified events. The method 500 may also identify 508 activities in which the user may participate during the travel window. The activity module 302, in one embodiment, may identify 508 activities.

The method 500, in one embodiment, correlates 510 events and/or activities with a calendar program of the user. In one embodiment, the method 500 uses planned travel identified in the calendar of the user to correlate 510 events and/or activities. In another embodiment, the method 500 identifies an open window in the calendar of the user for a travel window. One of skill in the art will recognize other ways for the method 500 to correlate 510 events and/or activities with a calendar of the user. In one embodiment, the calendar module 304 correlates 510 events and/or activities with the user's calendar.

The method 500 calculates 512 probability of the events occurring again at a particular location and within a travel window. In one embodiment, the probability module 306 calculates 512 the probability. The method 500 notifies 514 the user of the selected events and/or identified activities and of the probability of the events/activities occurring together again in the future at particular location and during a travel window. The method 500 interfaces 516 with ticket services, reservation services, and/or other reservation websites of the selected events to bring ticket purchase information to the user for the selected events, and the method 500 ends. The ticket module 308 may interface 516 with ticket services, reservation services, etc.

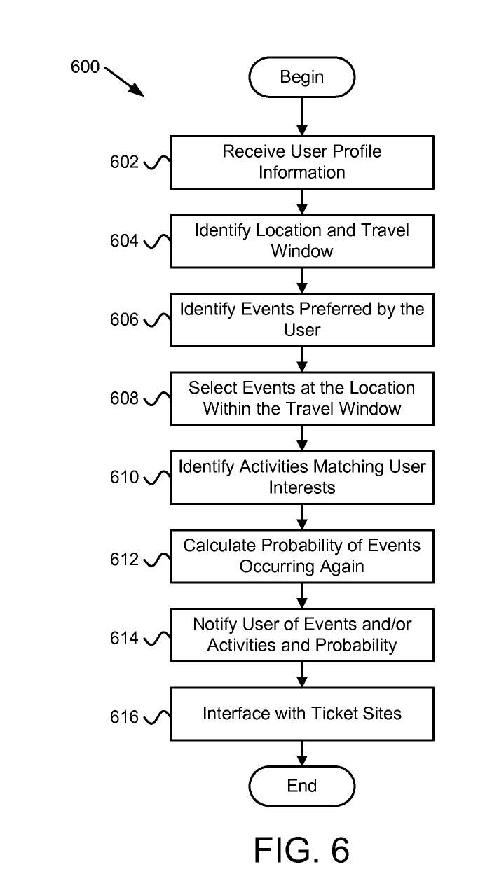

FIG. 6 is a schematic flow chart diagram illustrating a third embodiment of a method 600 for event identification in accordance with the present invention. The method 600 begins and receives 602 profile information of a user. The profile information includes activities and events preferred by the user and/or interests of the user. The method 600 identifies 604 a location and travel window. For example, the method 600 may receive input from the user regarding a location and a travel window. In another embodiment, the method 600 may interface with a calendar program, an email program, or other source of the user to determine travel plans to identify 604 a location and travel window.

The method 600 identifies 606 events that correspond to events preferred by the user and interests of the user where each event includes a location of the event and timing information of the event. The method 600 selects 608 events at the identified location and within the travel window. The event search module 204, in one embodiment, selects 608 events at the identified location and within the travel window.

The method 600 identifies 610 activities matching interests of the user within the specified distance and may also identify 610 activities in which the user may participate during the travel window. The activity module 302, in one embodiment, may identify 610 activities.

The method 600 calculates 612, in one embodiment, probability of the events occurring again at a particular location and within a travel window. In one embodiment, the probability module 306 calculates 612 the probability. The method 600 notifies 614 the user of the selected events and/or identified activities and of the probability of the events/activities occurring together again in the future at particular location and during a travel window. The method 600 interfaces 616 with ticket services of the selected events to bring ticket purchase information to the user for the selected events, and the method 600 ends. The ticket module 308 may interface 616 with ticket services, reservation services, reservation websites, etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a user profile module that receives profile information of a user, the profile information comprising one or more of activities preferred by the user, events preferred by the user and interests of the user;
an event search module that identifies events that correspond to one or more of an event planned by the user, events preferred by the user and interests of the user, each event comprising a location of the event and timing information of the event;
a correlation module that selects two or more events identified by the event search module that occur within a travel window of time and within a specified distance; and
a notification module that notifies the user of the events selected by the correlation module,
wherein at least a portion of the user profile module, the event search module, the correlation module, and the notification module comprise one or more of hardware and executable code, the executable code stored on computer readable storage media.

2. The apparatus of claim 1, further comprising an activity module that identifies activities matching interests of the user within the specified distance of the selected events, the identified activities comprising activities in which the user may participate within the travel window, wherein the notification module further notifies the user of the identified activities.

3. The apparatus of claim 2, further comprising a calendar module that interfaces with a calendar program of a user to determine a travel time and a travel location of the user, wherein one or more of
the correlation module selects events identified by the event search module that occur at the travel location during one or more of the travel time and within a specified time just before or after the travel time of the user; and
the activity module identifies activities matching interests of the user at the travel location of the user and during one or more of the travel time and a specified time just before or after the travel time of the user.

4. The apparatus of claim 2, wherein the activity module further interfaces with one or more websites that provide information regarding activities matching interests of the user such that the activity module identifies activities that are one or more of available to the user at the time of the travel window and are predicted to be above a quality threshold during the travel window.

5. The apparatus of claim 1, wherein the travel window comprises an amount of time a user allocates for a vacation.

6. The apparatus of claim 1, wherein the profile information received by the user profile module comprises profile information for two or more users with one or more events preferred by the two or more users and interests of the two or more users.

7. The apparatus of claim 1, wherein the specified distance comprises a maximum distance the user determines that the user is willing travel after arriving to attend the identified events, the maximum distance comprising one or more of a radius from a location, a distance between events, and a distance from a point near the location of the identified events.

8. The apparatus of claim 1, further comprising a probability module that calculates a probability of the events selected by the correlation module occurring at a future time at a location and within a travel window and communicates the probability to the user.

9. The apparatus of claim 1, wherein the user profile module receives profile information from the user through one or more of a website and an electronic device.

10. The apparatus of claim 1, wherein the event search module searches the internet using a web crawler.

11. The apparatus of claim 1, wherein the user profile module determines preferred location information, preferred location information comprising geographic locations that the user prefers to travel.

12. The apparatus of claim 11, wherein the user profile module determines preferred location information by one or more of input from the user and determining frequent travel destinations of the user.

13. The apparatus of claim 1, wherein the user profile module further receives profile information of the user that includes budget constraint information and wherein the correlation module selects events that comply with budget constraints received by the user profile module.

14. The apparatus of claim 1, further comprising a ticket module that interfaces with one or more of ticket services, reservation services, and reservation websites of the events selected by the correlation module to bring ticket purchase information to the user for the selected events.

15. The apparatus of claim 1, further comprising an itinerary module that creates an itinerary for the user, the itinerary comprising events selected by the correlation module and within the travel window.

16. A method comprising:
receiving profile information of a user, the profile information comprising one or more of activities preferred by the user, events preferred by the user and interests of the user;
identifying events that correspond to one or more of an event planned by the user, events preferred by the user and interests of the user, each event comprising a location of the event and timing information of the event;
selecting two or more identified events that occur within a travel window and within a specified distance; and
notifying the user of the selected events.

17. The method of claim 16, further comprising identifying activities matching interests of the user within the specified distance of the selected events, the identified activities comprising activities in which the user may participate within the travel window, and further comprising notifying the user of the identified activities.

18. The method of claim 16, further comprising interfacing with a calendar program of the user to determine a travel time and a travel location of the user.

19. A method comprising:
receiving profile information of a user, the profile information comprising one or more of activities preferred by the user, events preferred by the user and interests of the user;
identifying a travel location and a travel window of time of the user;
identifying events that correspond to one or more of an event planned by the user, events preferred by the user and interests of the user, each event comprising a location of the event and timing information of the event;
selecting one or more identified events that occur within the travel window and within a specified distance of the travel location; and
notifying the user of the selected events.

20. The method of claim 19, wherein identifying a travel location comprises one or more of
receiving input from the user identifying the travel location and the travel time of the user; and
interfacing with a calendar program of the user to determine the travel time and the travel location of the user.
